(19) United States
(12) Patent Application Publication
(10) Pub. No.: US 2020/0331035 A1
(43) Pub. Date: Oct. 22, 2020

(54) AUTOMATIC NOZZLE CLEANING-INSPECTION MANAGEMENT SYSTEM

(71) Applicant: BOSUNG ENG CO., LTD., Gyeonggi-do (KR)

(72) Inventor: Chan Sung CHUNG, Gyeonggi-do (KR)

(21) Appl. No.: 16/390,187

(22) Filed: Apr. 22, 2019

(30) Foreign Application Priority Data
Apr. 16, 2019 (KR) 10-2019-0044325

(51) Int. Cl. B08B 1/02; B08B 3/02; B08B 5/02; B08B 7/04

(52) U.S. Cl. CPC B08B 1/02; B08B 7/04; B08B 5/023; B08B 3/022

(57) ABSTRACT

An automatic nozzle cleaning-inspection management system includes a nozzle plate on which target nozzles to be cleaned are arranged, a cleaning chamber including a cleaning portion which cleans the target nozzles, a drying chamber including a drying portion which dries the target nozzles, an inspection chamber including an inspection portion which checks cleaned states of the target nozzles, and a transferring portion which transfers the nozzle plate, wherein the cleaning chamber, the drying chamber, and the inspection chamber are sequentially arranged in a line.

### CROSS-REFERENCE TO RELATED APPLICATION(S)

This application claims the benefit under 35 USC § 119(a) of Korean Patent Application No. 10-2019-0044325, filed on Apr. 16, 2019, in the Korean Intellectual Property Office, the entire disclosure of which is incorporated herein by reference for all purposes.

### BACKGROUND

### 1. Field

The following description relates to an automatic nozzle cleaning-inspection management system.

### 2. Description of Related Art

Vacuum adsorption methods through semiconductor chip transfer nozzles are used in semiconductor process, electronic process, electric field process, and the like, which require precision. However, when foreign substances, such as dust, are present inside vacuum adsorption nozzles due to repeated use of the nozzles, vacuum adsorption of the semiconductor chip becomes unstable, which may cause defects in the semiconductor process, electronic process, electric field process, and the like requiring precise operation. Accordingly, the nozzles for use in the semiconductor processes described above must be kept clean all the time. Conventionally, the nozzles are cleaned by an ultrasonic cleaning method, a cleaning fluid spraying method, and the like.

However, in order to reuse the nozzles after cleaning, it is required to completely dry the inside of the nozzles. Conventionally, there is an inconvenience in that an operator has to manually dry the cleaned nozzles or separately move the cleaned nozzles into a drying chamber, and to check cleaned and dried state of each individual nozzle. Especially inspection of the inner and outer surfaces of the nozzles was also manually performed by the operator, which may cause a problem of lowering the productivity and increasing the cost.

In other words, conventionally, the cleaning process of the nozzles, the drying process, and the checking process (inspection) of the cleaned nozzles are separately manually performed, and accordingly it is possible to clean only about 40 nozzles at most. Also, it is difficult to clean a large quantity of nozzles, so that the nozzle cleaning efficiency of the operator is significantly reduced. Moreover, since each process is manually performed, it is difficult to manage the whole working process.

Therefore, there is a need for an automatic nozzle cleaning-inspection management system in which all processes including nozzle cleaning, drying, inspection of the inner-outer surfaces of the nozzles, and barcode management are integrated and a large number of nozzles can be continuously fed through a lift or the like so that the entire process from the feeding of nozzles to the inspection can be automated and intellectualized, and thereby the operator is not required to manually check during the execution of each process.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide an automatic nozzle cleaning-inspection management system which integrates a process of cleaning inner diameter holes of nozzles, a drying process, and an inspection process into a single apparatus, thereby improving an efficiency of the nozzle cleaning operation.

In addition, the disclosed embodiments are indented to provide an automatic nozzle cleaning-inspection management system which allows a nozzle plate to be automatically moved from one process to another process for cleaning, drying and inspection of nozzles, thereby improving operation efficiency.

Further, the disclosed embodiments are intended to provide an automatic nozzle cleaning-inspection management system which maintains cleaning quality of inner diameter holes of nozzles uniformly, as well as improves the cleaning performance, thereby improving the quality reliability.

In one general aspect, there is provided an automatic nozzle cleaning-inspection management system including: a nozzle plate on which target nozzles to be cleaned are arranged; a cleaning chamber including a cleaning portion which cleans the target nozzles; a drying chamber including a drying portion which dries the target nozzles; an inspection chamber including an inspection portion which checks cleaned states of the target nozzles; and a transferring portion which transfers the nozzle plate, wherein the cleaning chamber, the drying chamber, and the inspection chamber are sequentially arranged in a line.

The automatic nozzle cleaning-inspection management system may further include a plurality of partitioning portions which separate the cleaning chamber, the drying chamber, and the inspection chamber from one another.

Each of the plurality of partitioning portions may include a partitioning plate, a transfer passage penetrating through the partitioning plate to allow the nozzle plate to pass therethrough, and an opening/closing portion capable of opening or closing the transfer passage.

In each of the cleaning chamber, the drying chamber, and the inspection chamber, a guide frame for supporting and guiding the nozzle plate may be formed to extend a predetermined length along a transferring direction of the nozzle plate.

The guide frame may include a pair of guide frame members facing each other with the nozzle plate interposed therebetween and each of the pair of guide frame members may have a plurality of roller portions formed to be in contact with and support a side surface of the nozzle plate.

Jig portions which fix a position of the nozzle plate in each of the cleaning chamber, the drying chamber, and the inspection chamber may be formed on at least one side of the pair of guide frame members.

The transferring portion may include at least one gripping portion horizontally movable along a transferring direction of the nozzle plate and capable of gripping the nozzle plate.

The transferring portion may further include a transferring bar horizontally movable along the transferring direction of the nozzle plate and the at least one gripping portion may be coupled to the transferring bar.

The nozzle plate may have a fixed member formed thereon and each of the at least one gripping portion may have a coupling member which is capable of moving toward and away from the nozzle plate and being coupled to the fixed member.

The nozzle plate may include a plurality of insertion grooves each of which accommodates each of the plurality of target nozzles and the plurality of insertion grooves may be arranged in a plurality of rows by a plurality of columns.

The cleaning portion may include a cleaning nozzle block which is positioned at least one of above and below the nozzle plate and cleans the target nozzles.

The cleaning nozzle block may include a plurality of cleaning nozzles and the plurality of cleaning nozzles may be arranged in at least one row by a plurality of columns.

The plurality of cleaning nozzles may be capable of selectively spraying droplets of a cleaning fluid or compressed air.

The cleaning nozzle block may be movable along a first direction perpendicular to the ground and a second direction in which the nozzle plate is transferred.

The drying portion may include a drying nozzle block which is positioned at least one of above and below the nozzle plate and dries the target nozzles.

The inspection portion may include an inspection module which checks the cleaned state of each of the target nozzles and the inspection module may be movable in three directions along a first direction perpendicular to the ground, a second direction in which the nozzle plate is transferred, and a third direction orthogonal to the first direction and the third direction.

The inspection portion may further include a recognition portion which recognizes barcode of each of the target nozzles disposed on the nozzle plate and the inspection chamber may further include a data storage portion which stores the barcode of each of the target nozzles and a corresponding result of the cleaned state of each of the target nozzles.

The automatic nozzle cleaning-inspection management system may further include a lift portion which is capable of accommodating a plurality of nozzle plates and feeds each of the plurality of nozzle plates sequentially into the cleaning chamber.

Other features and aspects will be apparent from the following detailed description, the drawings, and the claims.

### BRIEF DESCRIPTION OF THE DRAWINGS

FIG. 1 is a perspective view of one side of an automatic nozzle cleaning-inspection management system according to one embodiment of the present disclosure.

FIG. 2 is a perspective view of another side of the automatic nozzle cleaning-inspection management system illustrated in FIG. 1.

FIG. 3 is a bottom-side perspective view of the automatic nozzle cleaning-inspection management system according to one embodiment of the present disclosure.

FIG. 4 is a side view of the automatic nozzle cleaning-inspection management system according to one embodiment of the present disclosure.

FIG. 5 is a view of the automatic nozzle cleaning-inspection management system according to one embodiment of the present disclosure along a direction in which a nozzle plate is transferred.

FIG. 6 is an enlarged view of a part of a gripping portion of the automatic nozzle cleaning-inspection management system according to one embodiment of the present disclosure.

FIG. 7 is a view of a nozzle plate of the automatic nozzle cleaning-inspection management system according to one embodiment of the present disclosure.

FIG. 8 is an enlarged view of a cleaning chamber of the automatic nozzle cleaning-inspection management system according to one embodiment of the present disclosure.

FIG. 9 is an enlarged view of a drying chamber of the automatic nozzle cleaning-inspection management system according to one embodiment of the present disclosure.

FIG. 10 is an enlarged view of an inspection chamber of the automatic nozzle cleaning-inspection management system illustrated in FIG. 3.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, specific embodiments of the present disclosure will be described in accordance with the following drawings, however, they are only exemplary embodiments of the disclosure, and the present disclosure is not limited thereto.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context.

The spirit and scope of the disclosure are defined by the appended claims. The following embodiments are only made to efficiently describe the progressive technological scope of the present disclosure to those skilled in the art.

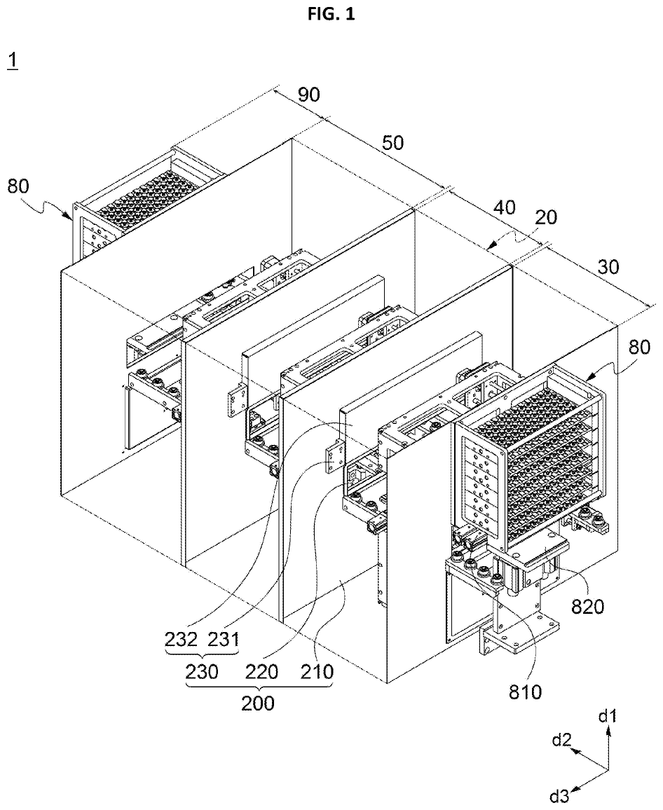

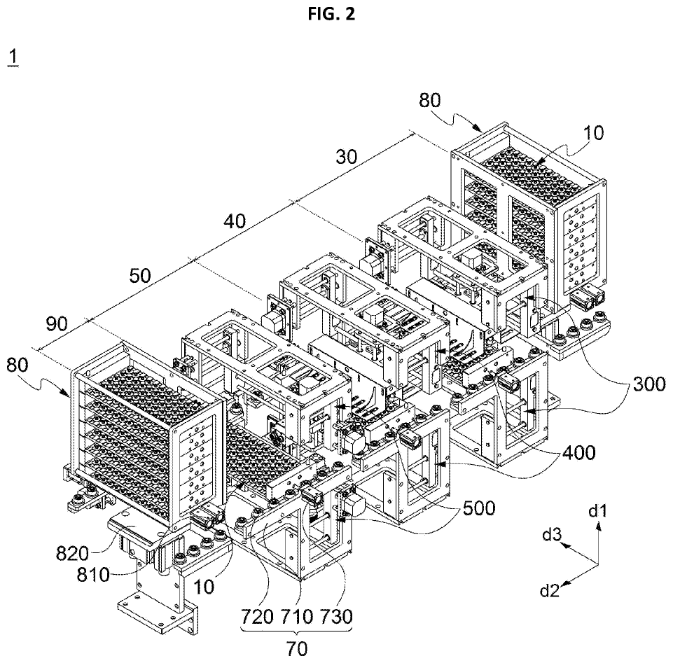

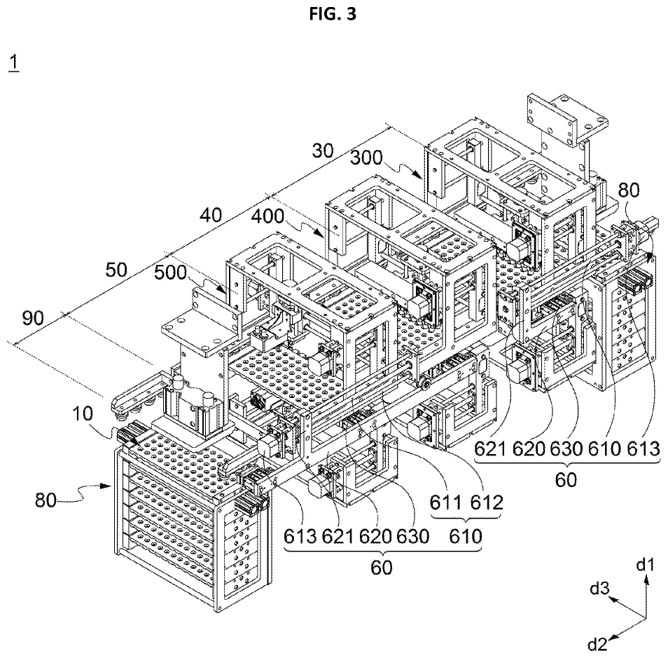

FIG. 1 is a perspective view of one side of an automatic nozzle cleaning-inspection management system 1 according to one embodiment of the present disclosure, FIG. 2 is a perspective view of another side of the automatic nozzle cleaning-inspection management system 1 according to one embodiment of the present disclosure, and FIG. 3 is a bottom-side perspective view of the automatic nozzle cleaning-inspection management system 1 according to one embodiment of the present disclosure. Herein, for convention of description, a housing portion 20 and partitioning portions 200 will be omitted from FIG. 2 and the following drawings.

Referring to FIGS. 1 to 3, the automatic nozzle cleaning-inspection management system 1 according to one embodiment of the present disclosure may include a nozzle plate 10 on which target nozzles to be cleaned are arranged a cleaning chamber 30 including a cleaning portion 300 which cleans the target nozzles, a drying chamber 40 including a drying portion 400 which dries the target nozzles, and an inspection chamber 50 including an inspection portion 500 which checks the cleaned target nozzles. In this case, the cleaning chamber 30, the drying chamber 40, and the inspection chamber 50 may be sequentially arranged in a line.

In addition, the automatic nozzle cleaning-inspection management system 1 according to one embodiment of the present disclosure may further include a transferring portion 60 which transfers the nozzle plate 10, and the transferring portion 60 may allow the nozzle plate 10 to sequentially pass through the cleaning chamber 30, the drying chamber 40, and the inspection chamber 50. That is, the nozzle plate 10 fed into the cleaning chamber 30 may be automatically transferred by the transferring portion 60 and may sequentially pass through the drying chamber 40 and the inspection chamber 50 so that cleaning, drying and inspection of the target nozzles arranged on the nozzle plate 10 can be performed.

In this case, the automatic nozzle cleaning-inspection management system 1 according to one embodiment of the present disclosure may clean, dry, and inspect not only the target nozzles arranged on the single nozzle plate 10 by passing the single nozzle plate 10 through the cleaning chamber 30, the drying chamber 40, and the inspection chamber 50, but also a large quantity of target nozzles by continuously passing a plurality of nozzle plates 10 through the cleaning chamber 30, the drying chamber 40, and the inspection chamber 50. That is, when the first nozzle plate 10 is moved from the drying chamber 40 to the inspection chamber 50, the second nozzle plate 10 may be moved from the cleaning chamber 30 to the drying chamber 40 and the third nozzle plate 10 may be continuously fed into the cleaning chamber 30.

Meanwhile, the automatic nozzle cleaning-inspection management system 1 according to one embodiment of the present disclosure may further include a discharge portion 90 placed adjacent to the inspection chamber 50. The discharge portion 90 may be formed on the opposite side of the drying chamber 40 with respect to the inspection chamber 50 and the cleaning chamber 30, the drying chamber 40, the inspection chamber 50, and the discharge portion 90 may be sequentially arranged in a line. In addition, the nozzle plate 10 which has been cleaned, dried, and inspected may be discharged to the discharge portion 90 by the transferring portion 60.

Meanwhile, the automatic nozzle cleaning-inspection management system according to one embodiment of the present disclosure may further include a lift portion 80 which can accommodate a plurality of nozzle plates 10 and may feed sequentially each of the plurality of nozzle plates 10 into the cleaning chamber 30 or allow a plurality of nozzle plates 10 to be sequentially stacked atop one another in the discharge portion 90. In this case, the lift portion 80 may be placed adjacent to the cleaning chamber 30, on the outside of a housing portion 20.

Specifically, the plurality of nozzle plates 10 stacked atop one another may be accommodated in the lift portion 80 and the nozzle plate 10 positioned at the same height as that of a guide frame 70 may be automatically moved into the cleaning chamber 30. Then, the plurality of stacked nozzle plates 10 may be sequentially lifted up and when the nozzle plate 10 inside the cleaning chamber 30 is transferred, again the nozzle plate 10 positioned at the same height as that of the guide frame 70 is fed into the cleaning chamber 30.

Meanwhile, the plurality of nozzle plates 10 may be stacked atop one another via fixed members 11 which will be described below. In this case, the lift portion 80 may include at least one height fixing portion 810 which is coupled to the fixed members 11, thereby being capable of fixing a position of the nozzle plates 10. In addition, the lift portion 80 may further include a lift support portion 820 which may be positioned below the plurality of nozzle plates 10 and support and move up or down the lowermost nozzle plate 10.

Meanwhile, the automatic nozzle cleaning-inspection management system 1 according to one embodiment of the present disclosure may further include the housing portion 20 which accommodates the cleaning chamber 30, the drying chamber 40, and the inspection chamber 50. On the other hand, the discharge portion 90 may be formed on the outside of the housing portion 20 and an operator may easily collect the nozzle plate 10 which has been cleaned, dried and inspected.

In this case, the housing portion 20 may further include a plurality of partitioning portions 200 which separate the cleaning chamber 30, the drying chamber 40, the inspection chamber 50, and the discharge portion 90 from one another. In addition, each of the plurality of partitioning portions 200 may be formed between the cleaning chamber 30 and the drying chamber 40, between the drying chamber 40 and the inspection chamber 50, and between the inspection chamber 50 and the discharge portion 90 so as to divide adjacent spaces.

Meanwhile, each of the plurality of partitioning portions 200 may include a plate-shaped partition plate 210, a transfer passage 220 penetrating through the partition plate 210 to allow the nozzle plate 10 to pass therethrough, and an opening/closing portion 230 capable of opening or closing the transfer passage 220.

In this case, the transfer passage 220 may be formed to have a size enough to allow the nozzle plate 10 to pass therethrough, and may preferably be formed in a rectangular shape. In addition, the above-described opening/closing portion 230 may include a pair of sliding guides 231 disposed in a vertical direction on a side of the transfer passage 220 and a slide panel 232 movable upward and downward along the sliding guide 231.

Furthermore, each of the above-described opening/closing portions 230 may be disposed between the cleaning chamber 30 and the drying chamber 40 and between the drying chamber 40 and the inspection chamber 50 so as to close the transfer passages 220 while the cleaning of the nozzles, the drying of the nozzles, and the inspection of the cleaned state are performed in the cleaning chamber 30, the drying chamber 40, and the inspection chamber 50, respectively, and may open the transfer passages 220 to allow the nozzle plate 10 to pass therethrough when the cleaning of the nozzles, the drying of the nozzles, and the inspection of the cleaned state are completed.

For example, when the nozzle plate 10 is fed into the cleaning chamber 30, the opening/closing portion 230 disposed between the cleaning chamber 30 and the drying chamber 40 may close the transfer passage 220 as the slide panel 232 moves downwards, and when driving of the cleaning portion 300 is finished, the opening/closing portion 230 may open the transfer passage 220 as the slide panel 232 moves upwards. Simultaneously, the opening/closing portion 230 disposed between the drying chamber 40 and the inspection chamber 50 may close the transfer passage 220 as the slide panel 232 moves downwards when the cleaned nozzle plate 10 is moved into the drying chamber 40, and may open the transfer passage 20 as the slide panel 232 moves upwards when driving of the drying portion 400 is finished.

Meanwhile, each of the plurality of slide panels 232 may be automatically moved upwards and downwards by means of connection or the like with a motor (not shown), a rack (not shown), and a pinion gear (not shown). Preferably, when the nozzle plate 10 passes through the transfer passage 220, the plurality of slide panels 232 may simultaneously move downwards so as to close the transfer passages 220 during operations of the cleaning portion 300, the drying portion 400, and the inspection portion 500, and when the operations of the cleaning portion 300, the drying portion 400, and the inspection portion 500 are completed, the plurality of slide panels 232 may simultaneously move upwards so as to open the transfer passages 220.

As described above, the plurality of transfer passages 220 are all closed while cleaning of the nozzles, drying of the nozzles, and inspection of the cleaned state are performed, so that a process of each of the cleaning chamber 30, the drying chamber 40, and the inspection chamber 50 can be performed in a separated independent environment and an efficiency of each process can be prevented from deteriorating due to permeation of the cleaning fluid of the cleaning portion 300 or warm drying air of the drying portion 400 into the adjacent space (the cleaning chamber 30, the drying chamber 40, or the inspection chamber 50).

In addition, in each of the cleaning chamber 30, the drying chamber 40, the inspection chamber 50, and the discharge portion 90, the guide frame 70 may be formed to extend a predetermined length along the transferring direction (a second direction d2) of the nozzle plate 10 so as to support and guide the nozzle plate 10. In this case, the guide frame 70 may include a pair of guide frame members 710 facing each other with the nozzle plate 10 interposed therebetween and each of the pair of guide frame members 710 may have a plurality of roller portions 720 formed to be in contact with and support a side surface of the nozzle plate 10.

Specifically, the above-described pair of guide frame members 710 may be formed in a bar shape having an L-shaped cross-section and extending a predetermined length and the plurality of roller portions 720 may be placed in a line on each guide frame member 710 along the second direction d2. In addition, a jig portion 730 for fixing the position of the nozzle plate 10 may be formed on at least one side of the pair of guide frame members 710 placed in each of the cleaning chamber 30, the drying chamber 40, the inspection chamber 50, and the discharge portion 90.

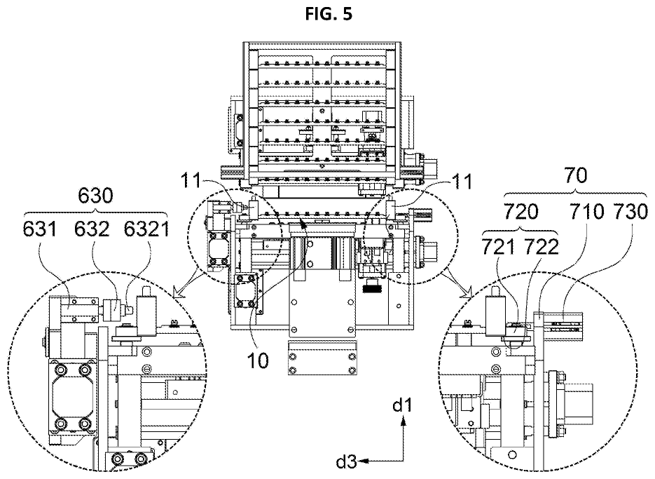

Meanwhile, a detailed shape of the roller portion 720, a contact support structure for the nozzle plate 10, and an operational structure of the jig portion 730 will be described in detail with reference to FIG. 5.

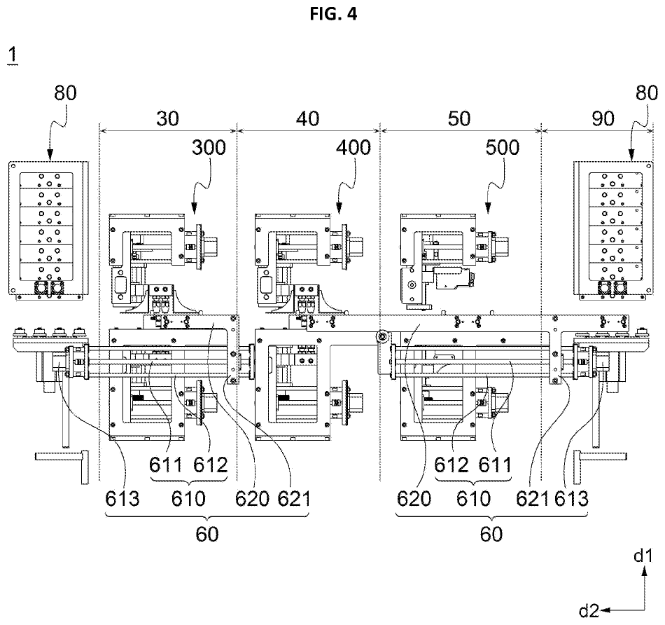

FIG. 4 is a side view of the automatic nozzle cleaning-inspection management system 1 according to one embodiment of the present disclosure.

Referring to FIG. 4, the above-described transferring portion 60 may include a transferring bar 620 horizontally movable along the transferring direction (the second direction d2) of the nozzle plate 10 and at least one gripping portion 630 which is coupled to the transferring bar 620 and horizontally movable and is capable of gripping the nozzle plate 10.

In addition, the transferring portion 60 may include a plurality of transferring shafts 610 interposed between two adjacent partitioning portions 200 among the above-described plurality of partitioning portions 200 and fixed to each of the two adjacent partitioning portions 200, and a transferring motor 613 capable of rotating one of the plurality of transferring shafts 610. Furthermore, the transferring bar 620 may include an extending portion 621 which is disposed on the above-described plurality of transferring shafts 610 and movable along the longitudinal direction of the plurality of transferring shafts 610.

Specifically, the transferring motor 613 may be fixed on one side of the two adjacent partitioning portions 200 and the plurality of transferring shafts 610 may be arranged in a line between the two adjacent partitioning portions 200 along a direction (a first direction d1) perpendicular to the ground. In this case, one (a first transferring shaft 611) of the plurality of transferring shafts 610 may have threads (not shown) on an outer surface thereof. Meanwhile, the extending portion 621 of the transferring bar 620 may be engaged to the plurality of transferring shafts 610.

In this case, thread grooves (not shown) may be formed on a part of the extending portion 621 which is engaged to the first transferring shaft 611, and the extending portion 621 may be screw-coupled to the first transferring shaft 611. In addition, the transferring portion 60 may be horizontally movably supported by a second transferring shaft 612 other than the first transferring shaft 611 among the plurality of transferring shafts 610

Therefore, the extending portion 621 may horizontally move along the second direction d2 while being supported by the second transferring shaft 612 as the first transferring shaft 611 is rotated by the transferring motor 613. Meanwhile, the transferring portion 60 may be positioned outside in a width direction (a third direction d3 perpendicular to the first direction d1 and the second direction d2) of one part of the guide frame 70. That is, the transferring portion 60 may be positioned on an outer side of a transferring path of the nozzle plate 10.

Meanwhile, at least one gripping portion 630 may horizontally move along the second direction d2 in accordance with the horizontal movement of the transferring bar 620 described above. Preferably, four gripping portions 630 may be formed and arranged in a line with spacing equal to the spacing between the nozzle plates 10 which are respectively positioned in the lift portion 80 at the inlet side of the cleaning chamber 30, the cleaning chamber 30, the drying chamber 40, the inspection chamber 50, and the discharge portion 90.

Specifically, when a plurality of nozzle plates 10 are disposed in the cleaning chamber 30, the drying chamber 40, and the inspection chamber 50, respectively, and each process is completed, each of the four gripping portions 630 may grip each of the four nozzle plates 10 positioned in in the lift portion 80 at the inlet side of the cleaning chamber 30, the cleaning chamber 30, the drying chamber 40, and the inspection chamber 50. Thereafter, as the transferring portion 60 horizontally moves due to the driving of the transferring motor 613, the four nozzle plates 10 gripped by the respective four gripping portions 630 may be transferred along the guide frame 70 in the second direction d2 while being supported by the roller portions 720.

The above-described configurations of the four gripping portions 630 are illustrative, and only one gripping portion 630 may be provided to transfer a single nozzle plate 10 in the order of the cleaning chamber 30, the drying chamber 40, and the inspection chamber 50.

FIG. 5 is a side view of the automatic nozzle cleaning-inspection management system 1 according to one embodiment of the present disclosure along a direction (the second direction d2) in which the nozzle plate 10 is transferred.

Referring to FIG. 5, the nozzle plate 10 may be positioned to be supported by, and in contact with, the roller portions 720 formed on the pair of guide frame members 710. Specifically, the roller portions 720 may be rotatably coupled to the pair of guide frame members 710 to rotate with respect to a center axis. In addition, each of the plurality of roller portions 720 may include a bearing portion 721 which rotates in contact with the side surface of the nozzle plate 10 as the nozzle plate 10 is transferred and a seating portion 722 which is positioned below the bearing portion 721 and has a diameter larger than that of the bearing portion 721 and on which the nozzle plate 10 is seated and supported.

That is, the nozzle plate 10 may be gripped by the gripping portion 630 while being seated on the plurality of seating portions 722, and when the transferring portion 60 horizontally moves in the second direction d2, may be transferred along the guide frame 70 while being supported by, and in contact with, the bearing portions 721.

Meanwhile, the above-described jig portion 730 for fixing the position of the nozzle plate 10 may be formed on one guide frame member 710 placed opposite to the gripping portion 630, among the pair of guide frame members 710 positioned in each of the cleaning chamber 30, the drying chamber 40, the inspection chamber 50, and the discharge portion 90.

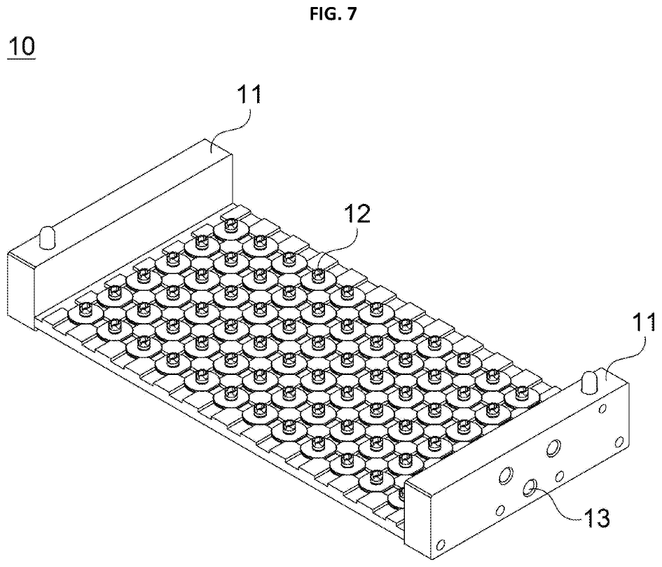

Specifically, each of a plurality of jig portions 730 may be formed using a hydraulic cylinder mechanism which linearly reciprocates a jig pin (not shown) inside of the jig portion 730, and the jig pin may be drawn toward the nozzle plate 10 as the jig portion 730 is operated. At this time, the drawn jig pin may be inserted into a jig groove 13 (shown in FIG. 7) formed on the fixing member 11 of the nozzle plate 10.

Accordingly, when the nozzle plate 10 is moved to a predetermined position in each of the cleaning chamber 30, the drying chamber 40, the inspection chamber 50, and the discharge portion 90, the jig pin may be drawn and inserted into the jig groove 13. That is, the nozzle plate 10 may be secured at a predetermined position by being gripped by the gripping portion 630 at one side in the third direction d3 and being restricted from moving by the jig portion 730 at the other side.

As described above, the nozzle plate 10 is firmly secured at a predetermined position by the above-described jig portion 730 and the gripping portion 630 in each of the cleaning chamber 30, the drying chamber 40, the inspection chamber 50, and the discharge portion 90 so that the accuracy and speed of each process during operations of the cleaning portion 300, the drying portion 400, and the inspection portion 500 can be improved.

Meanwhile, each of the gripping portions 630 described above may include a gripping cylinder 631 positioned outside of the guide frame 70 and a coupling member 632 coupled to the gripping cylinder 631 and moving toward and away from the nozzle plate 10 in accordance with the driving of the gripping cylinder 631. In addition, the fixed members 11 may be positioned at both sides of the nozzle plate 10 in the third direction, one fixed member 11 at the side of the gripping portion 630 may have a plurality of gripping grooves 14, and the coupling member 632 may be coupled and supported with the plurality of gripping grooves 14 in accordance with the operation of the gripping cylinder 631.

The coupling member 632 may be positioned above upper ends of the roller portion 720 and the guide frame 70 so that the coupling member 632 is not restricted by interference with the roller portion 720 and the guide frame 70 during the horizontal movement of the gripping portion 630.

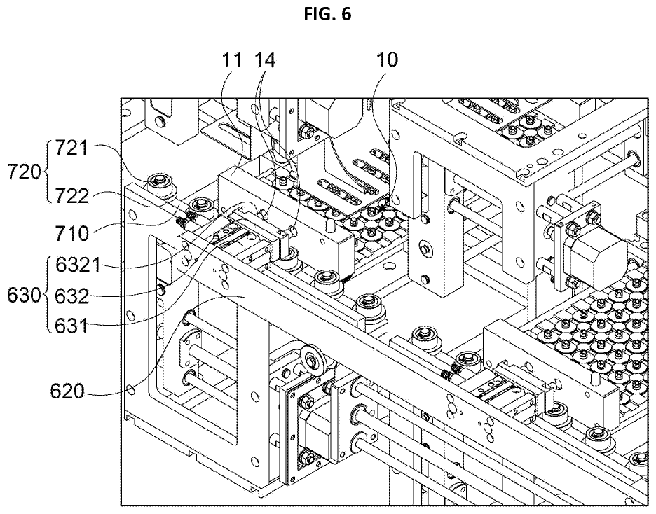

FIG. 6 is an enlarged view of a part of the gripping portion 630 of the automatic nozzle cleaning-inspection management system 1 according to one embodiment of the present disclosure.

Referring to FIG. 6, the plurality of gripping grooves 14 described above may be formed in a line on the fixed member 11 along the second direction d2 and the coupling member 632 may include a plurality of coupling portions protruding toward the fixed member 11. In this case, the plurality of coupling pins 6321 may be formed at intervals corresponding to intervals of the plurality of gripping grooves 14.

That is, the plurality of coupling pins 6321 may be inserted into the plurality of gripping grooves 14 as the coupling member 632 is moved, and the nozzle plate 10 may be gripped by the gripping portion 630 (more specifically, the coupling member 632) and be restricted from moving in the second direction d2.

FIG. 7 is a view of the nozzle plate 10 of the automatic nozzle cleaning-inspection management system 1 according to one embodiment of the present disclosure.

Referring to FIG. 7, each of the nozzle plates 10 may include a plurality of insertion grooves 12 each of which accommodates each of the above-described target nozzles to be cleaned. In this case, the plurality of insertion grooves 12 may be formed to penetrate through the nozzle plate 10. That is, as the insertion grooves 12 are formed to penetrate through the nozzle plate 10, one ends of the target nozzles may be exposed to one side of the nozzle plate 10 and the other ends of the target nozzles may be exposed to the other side of the nozzle plate 10.

In addition, the plurality of insertion grooves 12 may be formed in a plurality of rows by a plurality of columns. For example, the plurality of insertion grooves 12 may be arranged in 12 rows along the third direction d3 and 6 columns along the second direction d2, that is, a total of 72 (12*6) insertion grooves 12 may be formed.

Therefore, a large number of target nozzles to be cleaned may be accommodated and cleaned even with a single nozzle plate 10. Also, since the plurality of insertion grooves 12 can be formed at uniform intervals, the quality of cleaning, drying, and inspection processes of the target nozzles may be maintained constant.

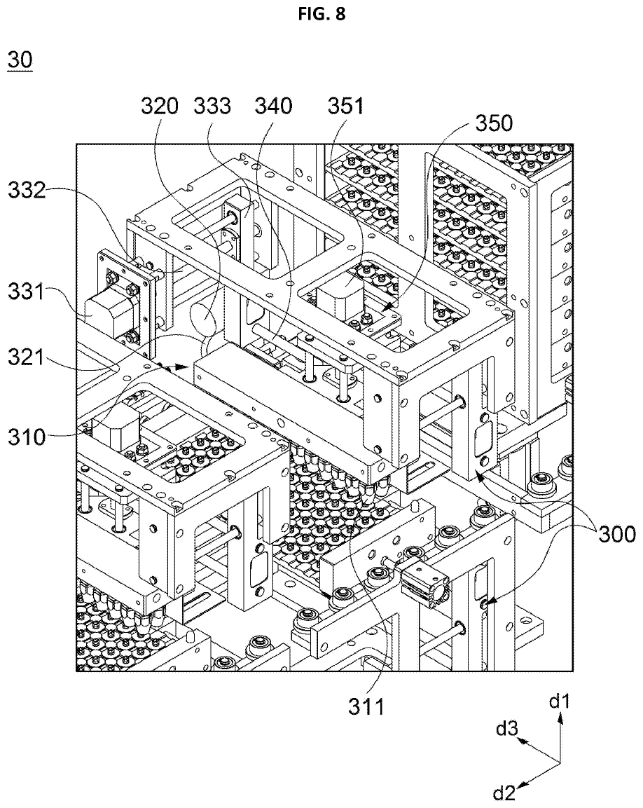

FIG. 8 is an enlarged view of the cleaning chamber 30 of the automatic nozzle cleaning-inspection management system 1 according to one embodiment of the present disclosure.

Referring to FIG. 8, the cleaning portion 300 disposed in the cleaning chamber 30 described above may be positioned at least one of above or below the nozzle plate 10 and may include a cleaning nozzle block 310 for cleaning target nozzles to be cleaned. In this case, preferably, the cleaning portion 300 may be positioned both above and below the nozzle plate 10.

Specifically, the cleaning nozzle block 310 may include a plurality of cleaning nozzles 311, and the plurality of cleaning nozzles 311 may be arranged in at least one row by a plurality of columns. In this case, the plurality of cleaning nozzles 311 may be arranged in a number of columns less than the number of columns of the insertion grooves formed on the nozzle plate 10 by the same number of rows as the rows of the insertion grooves in the third direction d3. For example, a total of 24 (12*2) cleaning nozzles 311 may be arranged in 12 rows along the third direction d3 and in two columns along the second direction.

Meanwhile, the cleaning nozzle block 310 of the cleaning portion 300 positioned above the nozzle plate 10 may spray droplets of a cleaning fluid downward toward each of the plurality of target nozzles arranged on the nozzle plate 10 and may clean an inner diameter hole of each of the target nozzles. Simultaneously, the cleaning nozzle block 310 of the cleaning portion 300 positioned below the nozzle plate 10 may spray droplets of the cleaning fluid upward toward each of the plurality of target nozzles arranged on the nozzle plate 10 and may clean the inner diameter hole of each of the target nozzles.

That is, in the automatic nozzle cleaning-inspection management system 1 according to one embodiment of the present disclosure, the cleaning portions 300 are provided both above and below the nozzle plate 10 to spray droplets of the cleaning fluid downward or upward so that foreign substances placed in the inner diameter of the target nozzle to be cleaned can be easily removed.

In addition, the plurality of cleaning nozzles 311 described above is capable of selectively spraying droplets of the cleaning fluid or compressed air.

Specifically, the cleaning portion 300 may further include a cleaning fluid tank 320 which is disposed on a side of the cleaning nozzle block 310 and supplies the cleaning fluid to the plurality of cleaning nozzles 311 through a cleaning fluid pipe 321. In addition, the cleaning portion 300 may further include a compressor (not shown) to supply compressed air to the cleaning nozzles 311, and the compressor may be connected to the cleaning fluid pipe 321. In this case, the cleaning fluid pipe 321 may have a valve (not shown) to selectively flow the cleaning fluid or compressed air.

On the other hand, when the target nozzles are cleaned by spraying the droplets of the cleaning fluid, preferably, the compressed air may be sequentially sprayed. At this time, the compressed air may easily remove the droplets of the cleaning fluid remaining on an inner circumferential surface of the target nozzle and may improve the speed of subsequent drying of the target nozzle by the drying portion 400.

The cleaning nozzle block 310 may be movable along the first direction d1 perpendicular to the ground and the second direction d2 in which the nozzle plate 10 is transferred. Specifically, the above-described cleaning portion 300 may include at least one first cleaning shaft 332 disposed at a predetermined length along the second direction d2, a pair of cleaning guides 333 disposed on and movable along the first cleaning shaft 332, at least one second cleaning shaft 340 fixed to the pair of cleaning guides and disposed at a predetermined length along the third direction d3, and a cleaning ascending and descending portion 350 disposed on the at least one second cleaning shaft 340.

In this case, the cleaning portion 300 may further include a first cleaning motor 331 capable of rotating the first cleaning shaft 332. In addition, the first cleaning shaft 332 and the pair of cleaning guides 333 are screw-coupled to each other, so that the pair of cleaning guides 333 may horizontally move along the second direction d2 in accordance with the rotation of the first cleaning shaft 332.

Further, the cleaning ascending and descending portion 350 may include a second cleaning motor 351 which is coupled to one side of the cleaning nozzle block 310 and raises or lowers the cleaning nozzle block 310 as it is driven. That is, the cleaning nozzle block 310 may be moved toward the nozzle plate 10 by driving the second cleaning motor 351.

For example, in a case where the inner diameters of the target nozzles are cleaned, the cleaning nozzle block 310 may be moved toward and brought into close contact with the nozzle plate 10, and when the cleaning is completed, the cleaning nozzle block 310 may be moved back away from the nozzle plate 10.

In addition, as the cleaning guides 333 are moved in the second direction d2, the cleaning nozzle block 310 coupled to the cleaning ascending and descending portion 350 may also be moved horizontally in the second direction d2. By doing so, when the cleaning nozzle block 310 has completely cleaned 24 target nozzles to be cleaned which are arranged on the nozzle plate 10, the cleaning nozzle block 310 may be moved in the second direction d2 and clean adjacent another 24 target nozzles to be cleaned.

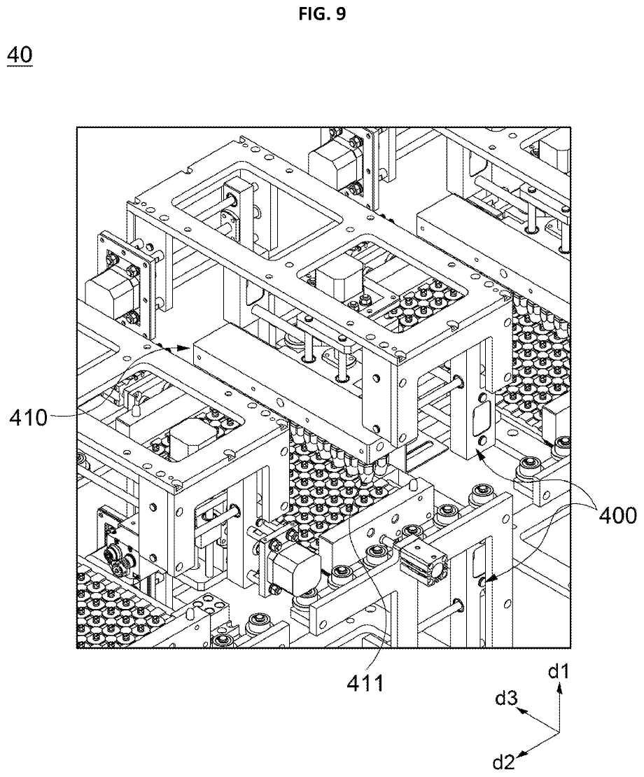

FIG. 9 is an enlarged view of the drying chamber 40 of the automatic nozzle cleaning-inspection management system 1 according to one embodiment of the present disclosure.

Referring to FIG. 9, the drying portion 400 disposed in the drying chamber 40 may include a drying nozzle block 410 which dries the target nozzles to be cleaned, and may be placed at least one of above and below the nozzle plate 10. Preferably, the drying portion 400 may be placed both above and below the nozzle plate 10.

Specifically, the drying nozzle block 410 may include a plurality of drying nozzles 411 and the plurality of drying nozzles 411 may be arranged in at least one row by a plurality of columns. For example, a total of 24 (12*2) drying nozzles 411 may be formed in 12 rows along the third direction d3 and 2 columns along the second direction d2 and be arranged in the same manner as the plurality of cleaning nozzles 311.

The drying nozzles 411 of the drying nozzle blocks 410 disposed above and below the nozzle plate 10 may direct warm air to the target nozzles to be cleaned. In so doing, it is possible to completely dry the cleaning fluid which may remain on the inner circumferential surfaces of the target nozzles to be cleaned despite the compressed air in the cleaning chamber 30.

Also, the drying nozzle block 410 may be movable along the first direction d1 perpendicular to the ground and the second direction d2 in which the nozzle plate 10 is transferred. In this case, a detailed operational method for the movement of the drying nozzle block 410 in the first direction d1 and the second direction d2 is substantially the same as the structure for the movement of the above-described cleaning nozzle block 310 in the first direction d1 and the second direction d2, and hence a detailed description thereof will not be reiterated.

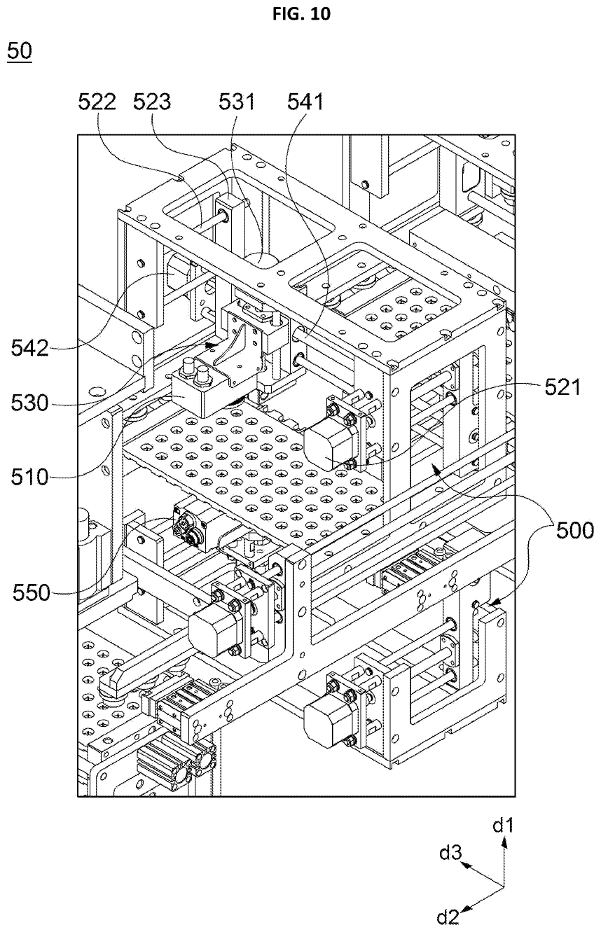

FIG. 10 is an enlarged view of the inspection chamber 50 of the automatic nozzle cleaning-inspection management system 1 illustrated in FIG. 3.

Referring to FIG. 10, the inspection portion 500 disposed in the inspection chamber 50 may include an inspection module 510 which checks the cleaned state of each of the target nozzles, and the inspection module 510 may be disposed above or below the nozzle plate 10. At this time, the inspection module 510 may emit light to the inside of a single target nozzle to be cleaned, and may confirm whether the cleaning fluid remains on the inner circumferential surface of the target nozzle through the emission of light.

In addition, the inspection module 510 may be formed to be movable in three directions along the first direction d1 perpendicular to the ground, the second direction d2 in which the nozzle plate 10 is transferred, and the third direction d3 orthogonal to the first direction d1 and the second direction d2.

Specifically, the inspection portion 500 may include at least one first inspection shaft 522 disposed at a predetermined length along the second direction d2, a pair of inspection guides 523 disposed on and movable along the first inspection shaft 522, at least one second inspection shaft 541 fixed to the pair of inspection guides 523 and disposed at a predetermined length along the third direction d3, and an inspection ascending and descending portion 530 disposed on the at least one second inspection shaft 541.

In this case, the inspection portion 500 may further include a first inspection motor 521 capable of rotating the first inspection shaft 522. In addition, the first inspection shaft 522 and the pair of inspection guides 523 are screw-coupled to each other, so that the pair of inspection guides 523 may horizontally move along the second direction d2 in accordance with the rotation of the first inspection shaft 522. Further, the inspection ascending and descending portion 530 may include a second inspection motor 531 which is coupled to one side of the inspection module 510 and raises or lowers the inspection module 510 as it is driven. That is, the inspection module 510 may be moved toward the nozzle plate 10 by driving the second inspection motor 531.

In addition, the inspection portion 500 may further include a third inspection motor 542 capable of rotating and moving the second inspection shaft 541. In this case, the inspection ascending and descending portion 530 and the second inspection shaft 541 may be screw-coupled to each other and the inspection ascending and descending portion 530 may be moved in the third direction d3 by driving the third inspection motor 542.

The inspection portion 500 may further include a recognition portion 550 which recognizes barcode of each of the target nozzles arranged on the nozzle plate 10, and the recognition portion 550 may be disposed below or above (i.e., at an opposite side of the inspection module 510) the nozzle plate 10. Typically, unique barcode is written on an outer surface of one side of the target nozzle to be cleaned and the recognition portion 550 may recognize the barcode written on each of the target nozzles to be cleaned.

Also, the recognition portion 550 may be movable in three directions along the first direction d1, the second direction, d2, and the third direction d3. Preferably, the inspection module 510 and the recognition portion 550 may simultaneously check the cleaned state of the same target nozzle and recognize the barcode. That is, the cleaned state of each of the target nozzles to be cleaned may be checked and the barcode of each of the target nozzles corresponding to each of the cleaned states may be recognized. In addition, the inspection chamber 50 may further include a data storage portion (not shown) which stores the barcode of each of the target nozzles and the corresponding result of cleaned state of each of the target nozzles. A user may easily identify and manage the cleaned state of each of the target nozzles through information (cleaned state and barcode) stored in the storage portion.

A detailed moving method of the recognition portion 550 is substantially the same as the moving method of the inspection module 510 described above, and hence a detailed description thereof will not be reiterated. Further, the automatic nozzle cleaning-inspection management system 1 according to one embodiment of the present disclosure may be interlocked with a manufacturing execution system (MES), thereby facilitating the real-time monitoring, checking of operation details, and status check for each process.

According to the embodiments of the present disclosure, a process of cleaning an inner diameter hole of a nozzle, a drying process, and an inspection process are integrated into one apparatus, thereby improving an efficiency of the nozzle cleaning operation.

Also, according to the embodiments of the present disclosure, since for the processes of cleaning, drying, and inspection of the nozzles, a nozzle plate is automatically moved from one process to another process, operation efficiency may be improved.

In addition, according to the embodiments of the present disclosure, the cleaning quality of the inner diameter holes of the nozzles is uniformly maintained and also cleaning performance is improved, and accordingly the quality reliability may be improved.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1: A automatic nozzle cleaning-inspection management system comprising:
a nozzle plate on which target nozzles to be cleaned are arranged;
a cleaning chamber including a cleaning portion which cleans the target nozzles;
a drying chamber including a drying portion which directs warm air to the target nozzles to dry the target nozzles;
an inspection chamber including an inspection portion which checks cleaned states of the target nozzles;
a transferring portion which transfers the nozzle plate; and
a lift portion which is capable of accommodating a plurality of nozzle plates and feeds each of the plurality of nozzle plates sequentially into the cleaning chamber,
wherein the cleaning chamber, the drying chamber, and the inspection chamber are sequentially arranged in a line;
the cleaning portion includes a cleaning nozzle block which is positioned above and below the nozzle plate and cleans the target nozzles;
the plurality of nozzle plates are stacked atop one another via fixed members having a predetermined height; and
the lift portion is coupled to the fixed members thereby being capable of fixing a position of the plurality of nozzle plates.

2: The automatic nozzle cleaning-inspection management system of claim 1, further comprising a plurality of partitioning portions which separate the cleaning chamber, the drying chamber, and the inspection chamber from one another.

3: The automatic nozzle cleaning-inspection management system of claim 2, wherein each of the plurality of partitioning portions includes a partitioning plate, a transfer passage penetrating through the partitioning plate to allow the nozzle plate to pass therethrough, and an opening/closing portion capable of opening or closing the transfer passage.

4: The automatic nozzle cleaning-inspection management system of claim 1, wherein in each of the cleaning chamber, the drying chamber, and the inspection chamber, a guide frame for supporting and guiding the nozzle plate is formed to extend a predetermined length along a transferring direction of the nozzle plate.

5: The automatic nozzle cleaning-inspection management system of claim 4, wherein the guide frame includes a pair of guide frame members facing each other with the nozzle plate interposed therebetween and each of the pair of guide frame members has a plurality of roller portions formed to be in contact with and support a side surface of the nozzle plate.

6: The automatic nozzle cleaning-inspection management system of claim 5, wherein jig portions which fix a position of the nozzle plate in each of the cleaning chamber, the drying chamber, and the inspection chamber are formed on at least one side of the pair of guide frame members.

7: The automatic nozzle cleaning-inspection management system of claim 1, wherein the transferring portion includes at least one gripping portion horizontally movable along a transferring direction of the nozzle plate and capable of gripping the nozzle plate.

8: The automatic nozzle cleaning-inspection management system of claim 7, wherein the transferring portion further includes a transferring bar horizontally movable along the transferring direction of the nozzle plate and the at least one gripping portion is coupled to the transferring bar.

9: The automatic nozzle cleaning-inspection management system of claim 7, wherein the nozzle plate has a fixed member formed thereon and each of the at least one gripping portion has a coupling member which is capable of moving toward and away from the nozzle plate and being coupled to the fixed member.

10: The automatic nozzle cleaning-inspection management system of claim 1, wherein the nozzle plate includes a plurality of insertion grooves each of which accommodates each of the plurality of target nozzles and the plurality of insertion grooves are arranged in a plurality of rows by a plurality of columns.

11: (canceled)

12: The automatic nozzle cleaning-inspection management system of claim 1, wherein the cleaning nozzle block includes a plurality of cleaning nozzles and the plurality of cleaning nozzles are arranged in at least one row by a plurality of columns.

13: The automatic nozzle cleaning-inspection management system of claim 12, wherein the plurality of cleaning nozzles are capable of selectively spraying droplets of a cleaning fluid or compressed air.

14: The automatic nozzle cleaning-inspection management system of claim 1, wherein the cleaning nozzle block is movable along a first direction perpendicular to the ground and a second direction in which the nozzle plate is transferred.

15: The automatic nozzle cleaning-inspection management system of claim 1, wherein the drying portion includes a drying nozzle block which is positioned at least one of above and below the nozzle plate and dries the target nozzles.

16: The automatic nozzle cleaning-inspection management system of claim 1, wherein the inspection portion includes an inspection module which checks the cleaned state of each of the target nozzles and the inspection module is movable in three directions along a first direction perpendicular to the ground, a second direction in which the nozzle plate is transferred, and a third direction orthogonal to the first direction and the third direction.

17: The automatic nozzle cleaning-inspection management system of claim 16, wherein the inspection portion further includes a recognition portion which recognizes barcode of each of the target nozzles disposed on the nozzle plate and the inspection chamber further includes a data storage portion which stores the barcode of each of the target nozzles and a corresponding result of the cleaned state of each of the target nozzles.

18: (canceled)
